(19) United States
(12) Patent Application Publication
(10) Pub. No.: US 2021/0228028 A1
(43) Pub. Date: Jul. 29, 2021

(54) HOUSEHOLD FOOD PREPARATION SYSTEM

(71) Applicant: VORWERK & CO. INTERHOLDING GMBH, Wuppertal (DE)

(72) Inventors: Stephen POHL, Wuppertal (DE); Torsten LANG, Solingen (DE); Simon STROH, Solingen (DE)

(21) Appl. No.: 17/130,702

(22) Filed: Dec. 22, 2020

(30) Foreign Application Priority Data
Jan. 28, 2020 (EP) 20154064.8

(51) Int. Cl. A47J 43/046; A47J 43/08

(52) U.S. Cl. CPC A47J 43/0465; A47J 2043/0733; A47J 43/085

(57) ABSTRACT

The present disclosure relates to a system of a food processor and a mixing device with a shareable vessel. The invention also relates to a mixing device for the system having a standing part and a vessel which can be inserted into the standing part or is integrated into the standing part. There is a mixing tool in the vessel, wherein the standing part comprises an electric drive with which the mixing tool can be driven.

### CROSS REFERENCE TO RELATED APPLICATIONS

This application claims priority to and the benefit of European Patent Application Number 20154064.8, filed 28 Jan. 2020, the disclosure of which is now expressly incorporated herein by reference.

### FIELD OF THE DISCLOSURE

The present disclosure relates to a system for a household with a food processor and a mixing device. The disclosure also relates to a mixing device for a household having a vessel and a mixing tool for the system. With the mixing tool the ingredients of a food which are located in the vessel can be mixed.

### BACKGROUND

A food processor with a vessel has and having a knife set have been introduced in the market. The food processor can chop, mill or solely mix the ingredients of a food located in the vessel. In order to chop the ingredients of a food, the knife set must be able to rotate at a high rotational speed and a high torque towards its sharp edge. The electric drive of such a food processor is chosen to be accordingly powerful.

In some food processors a mixing mechanism is provided with a permanent synchronous motor. The permanent synchronous motor comprises a plurality of permanent magnets arranged at regular distances around the circumference of the rotor of the electric motor.

A mixing device which comprises a vessel and a mixing tool may be constructed such that the mixing tool is integrated in a top piece for the vessel. The top piece can include a piezoelectric stepper motor as a drive. A piezoelectric stepper motor may be relatively small and light.

When preparing one or more foods, there is a regular need to mix first ingredients and chop and/or mix second ingredients. If only one food processor is available, these steps have to be performed successively in time. This problem could be solved by providing a second food processor. However, providing a second food processor to solve this problem is not very useful for reasons of cost and space.

### SUMMARY

The present disclosure is intended to simplify and accelerate the preparation of a food. In presented embodiments, a mixing device with a small space requirement is provided.

The disclosure specifically relates to a system comprising a food processor and a mixing device and at least one vessel with a mixing tool located therein. The vessel can be used both as part of the food processor and as part of the mixing device. The food processor is configured such that the mixing tool can be rotated at higher speeds by the food processor compared to the maximum speeds possible with the mixing device. This makes it possible to use the vessel as part of the food processor and later as part of the mixing device or vice versa, depending on the requirements during the preparation of a food. If the same ingredients are to be processed, there is no need to transfer the ingredients from the vessel of the food processor to the vessel of the mixing device or vice versa. The mixing device comprises a stepper motor as a drive for the mixing tool.

In one embodiment the system comprises a second vessel which is designed like the aforementioned vessel. If a food is prepared in the first-mentioned vessel by means of the food processor first and the vessel is later used in the mixing device as described above, the second vessel can be used to prepare another food in parallel by means of the food processor.

The food processor is preferably configured such that the direction of rotation of the mixing tool can be changed. The food processor can thus be used in an improved manner for pure mixing and alternatively for mixing and chopping of ingredients of a food.

The mixing device and/or the food processor may have an electronic control device. The operation of the food processor and/or the operation of the mixing device can be controlled by the control device if a control device is present.

### BRIEF DESCRIPTIONS OF THE DRAWINGS

FIG. 1 is a perspective, partially diagrammatic, view of a mixing device with standing part and insertable vessel;

FIG. 2 is a top plan view of a mixing tool;

FIG. 3 is a perspective, partially diagrammatic, view of a mixing device with standing part and integrated vessel;

FIG. 4 is an axial section through a hybrid stepper motor; and

FIG. 5 is a transverse section through a hybrid stepper motor.

### DETAILED DESCRIPTION

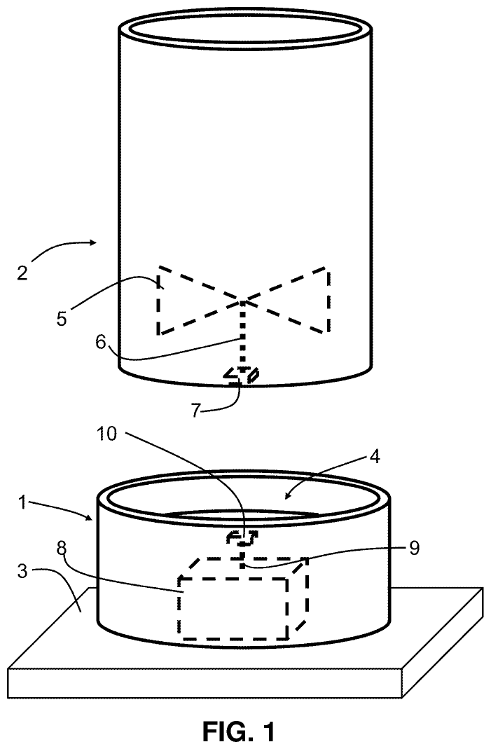

FIG. 1 shows a mixing device with a standing part 1 and a vessel 2. The standing part 1 is placed on a ground 3. The standing part 1 has a recess 4, which can accommodate a lower part of the vessel 2. The vessel 2 can therefore be inserted into the recess 4. The shape and diameter of the recess 4 are adapted to the shape and diameter of the lower part of vessel 2 to hold the vessel 2 safely and reliably by the standing part 1. The recess can be circular, as shown in FIG. 1. The lower portion of the vessel 2 is therefore also circular to ensure that the two shapes are matched. The outer diameter of the lower portion of the vessel 2 is slightly smaller than the inner diameter of the recess 4 to ensure that vessel 2 is held securely by the standing part. However, other shapes can also be provided. Preferably, vessel 2 can be inserted into recess 4 in a rotationally fixed manner. Thus, the recess 4 and the lower part of the vessel 2 can be triangular, quadrangle, pentagonal or oval, so that the vessel 2 can be inserted in a rotationally fixed manner into the standing part.

A mixing tool 5, indicated by dashed lines, is located in vessel 2, namely near the bottom of vessel 2, and therefore at the bottom of vessel 2. Mixing tool 5 can be rotated by a shaft 6. The shaft 6 passes through the bottom of vessel 2. The downward pointing end of shaft 6 comprises a coupling piece 7.

The standing part 1 comprises an electric motor 8 indicated by dashed lines with a shaft 9. The upward pointing end of the shaft 9 comprises a coupling piece 10. The electric motor 8 is a hybrid stepper motor.

When the vessel 2 is inserted into the recess 4, as a result the two coupling pieces 7 and 10 are connected with each other. If the shaft 9 of the motor 8 is rotated, the rotational movement is transferred from the shaft 9 to the shaft 6. Thus, the mixing tool 5 is rotated. A gearbox is not necessary, because suitable speeds can be set by a hybrid stepper motor even without a gearbox.

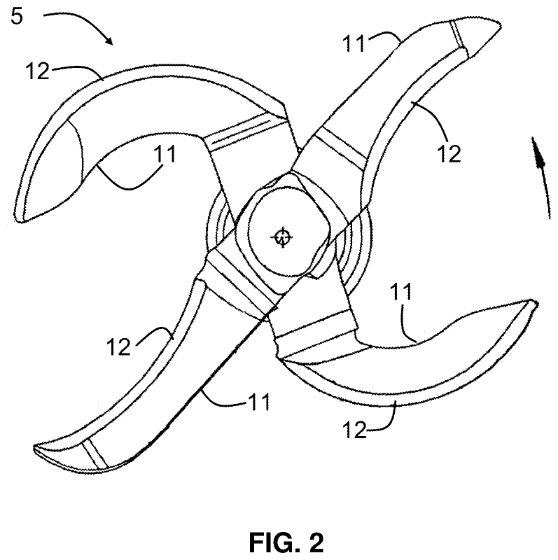

FIG. 2 shows an example of a mixing tool 5, which has a blunt edge 11 and an opposite sharp edge 12. If the mixing tool 11 is rotated counter-clockwise as indicated by an arrow, the mixing tool 11 is rotated in the direction of the blunt edge 11. A mixing device according to the present disclosure is principally configured such that the mixing tool 11 can only be rotated in the direction of the blunt edge 11.

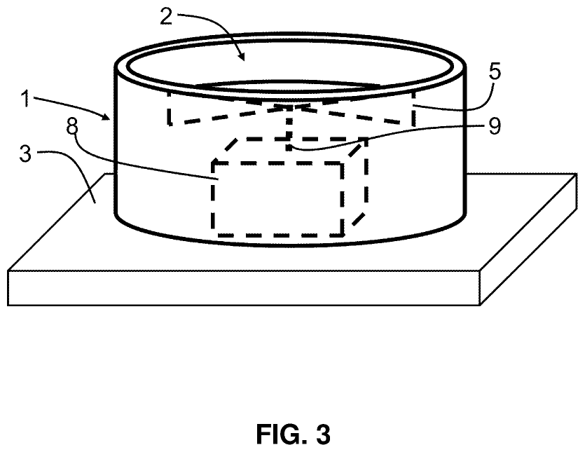

FIG. 3 shows an example of a mixing device where the vessel 2 is integrated into the standing part 1. The vessel 2 is therefore inseparably connected to standing part 1. In this embodiment, the mixing tool 5 can preferably be detached from the shaft 9 of the motor 8, so that it can be removed and easily cleaned.

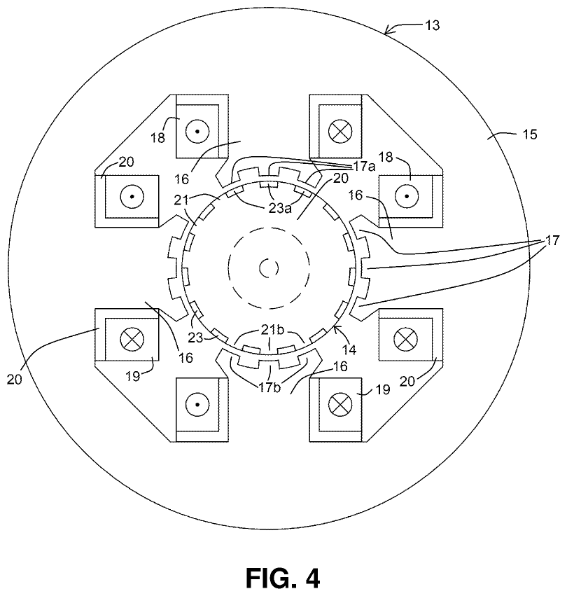

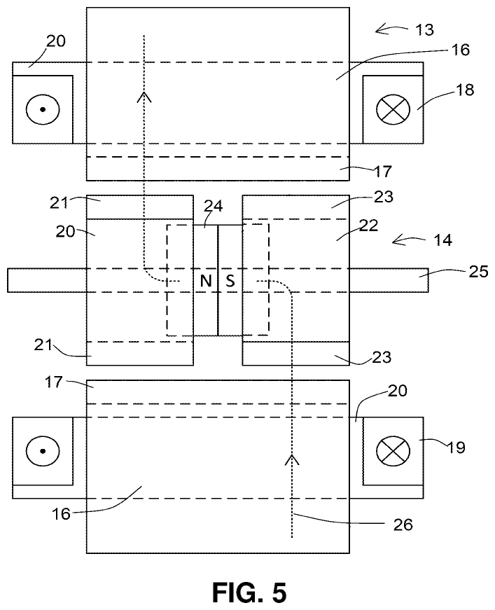

FIG. 4 shows an axial section through a hybrid stepper motor. FIG. 5 shows a transversal section of the hybrid stepper motor of FIG. 4. The hybrid stepper motor comprises a stator 13 and a rotor 14. The main body 15 of the stator 13 is preferably completely made of metal, so that the hybrid stepper motor has a high weight. The main body 15 of the stator 13 can consist of a number of metal sheets that are combined into a package. The metal sheets can be joined with each other by rivets.

The main body 15 comprises a plurality of segments 16. The segments 16 protrude inwardly from an annular shape of the main body 15. The outer contour of the annular shape can be circular as shown in FIG. 4. However, the outer contour of the annular shape can also be square, for example. There can be four segments 16 as shown in FIG. 4. However, there can also be six or eight segments 16, for example. Each segment 16 has a plurality of teeth 17 at its inward-facing end. Each segment 16 can have three teeth 17 as shown in FIG. 4. However, there can also be more or less than three teeth 17 per segment 16, for example, two, four, or five teeth 17. The segments with the teeth consist of a magnetizable material. It can be a ferromagnetic material, which for example contains mainly iron. However, it can also be a paramagnetic material.

A coil 18, 19 is wound around each segment 16. To ensure that the windings of coils 18, 19 are electrically insulated from the main body 15, if necessary, electrical insulation bodies 20 can be provided which electrically separate the windings of coils 18, 19 from the main body 15. During operation, at the appropriate time, a current flows through a coil 18 in the opposite direction to a current through a coil 19 to rotate the rotor. The direction of a possible current flow is indicated in FIG. 4 by a “●” and “×” representation for each coil 18, 19.

The rotor 14 is located inside the annular shape of the stator 13. The rotor 14 comprises a first rotational body 20, which is provided with first teeth 21, and a second rotational body 22 (see FIG. 5), which is provided with second teeth 23. The rotational bodies 20, 22 can be made of paramagnetic material. However, a ferromagnetic material is preferable for the rotational bodies 20, 22. One or both rotational bodies 20, 22, respectively, can consist of a plurality of metal sheets. The metal sheets of a rotational body can be connected to each other, for example by grooves or screws. Alternatively, one or both rotational body 20, 22, respectively, can be manufactured in one piece. A first tooth 21 is located between two second teeth 23 and vice versa, as shown in FIG. 4. The teeth 21, 23 of rotor 14 adjoin the teeth 17 of stator 13 in such a way that a narrow gap remains between them.

The teeth 21, 23 of the rotor 14 are preferably outwardly curved on their upper side such that the upper sides of teeth 21, 23 form an annular shape when viewed from above, as shown in FIG. 4. In a corresponding manner, the upper sides of teeth 17 of the stator are then preferably inwardly curved. This allows a particularly narrow gap to be set between the teeth 17 of the stator 13 on the one hand and the teeth 21, 23 of the rotor 14 on the other hand.

FIG. 5 illustrates that the north pole N of a permanent magnet 24 extends into the first rotational body 20 and the south pole S of the permanent magnet 24 extends into the second rotational body 22. The first teeth 21 therefore act as magnetic north pole and the second teeth 23 as magnetic south pole. As shown in FIG. 4, a first tooth 21 can be directly adjacent to a second tooth 23 when viewed in plan view, and a next first tooth 21 can be directly adjacent to the second tooth 23, so that there are no gaps between first and second teeth 21, 23 when viewed in plan view.

FIG. 4 illustrates that second teeth 23a have been moved by the teeth 17a of the upper coil 18 by reluctance force into the shown aligned position. The teeth 17a then lie exactly opposite the teeth 23a. In addition, first teeth 21a have been moved by the teeth 17b of the lower coil 19 by reluctance force into the shown aligned position. The teeth 17b then lie exactly opposite the teeth 21b. To achieve this, the current flows through the lower coil 19 in the opposite direction to the current flowing through the upper coil 18. No current flows through the side coils 18 and 19 during this time.

When the rotor 14 has reached the position shown in FIG. 4, the current flow through the upper coil 18 and the lower coil 19 is interrupted and a current then flows through the side coils 18, 19, again in the opposite direction. Since the laterally arranged teeth 17 of the stator 13 are arranged offset relative to the laterally arranged teeth 21 and 23 of the rotor 14, a reluctance force acts on the rotor 14 in such a way that it is rotated further in a counter-clockwise direction.

FIG. 5 shows that the shaft 25 of the hybrid stepper motor can pass through the permanent magnet 24 and the two rotational bodies 20, 22. FIG. 5 shows an example of the path 26 of a magnetic flux that can occur during operation of the hybrid stepper motor. The exemplary path shows that the magnetic flux penetrates the first teeth 21 and the second teeth 23. The magnetic flux passes through the first teeth 21 towards the outside of the first teeth 21. The magnetic flux passes through the second teeth 23 in an opposite direction, i.e. from the outside of the second teeth 23 towards the inside of the second teeth 23.

There is a control device not shown for the hybrid stepper motor, which controls the current flow as described above.

According to FIG. 5 there is only one permanent magnet 24. However, two or more permanent magnets can also be present, which extend into the rotational bodies 20, 22.

In some embodiments, the mixing device and/or the food processor are configured to exchange data with each other wirelessly. Data exchange can be used to control the operation of the mixing device or of the food processor by means of a control device.

The food processor and/or the mixing device may have a heating device as a device for the preparation of a food, by means of which the vessel can be heated. The food processor and/or the mixing device may comprise a control program to control the heating of the vessel. The heating device may comprise an electrical resistance heater to generate heat. The heating device may comprise a temperature sensor to detect, display and/or control temperatures.

In some embodiments, the vessel comprises a resistance heater as part of the heating device. This reduces the technical effort if a heating device is to be provided for both the food processor and the mixing device. Preferably, the vessel comprises a temperature sensor to detect, display and/or control temperatures.

As a device for the preparation of a food, a scale may be provided in the food processor and/or in the mixing device, which allows the weight of an ingredient or food introduced into the vessel to be weighed. The food processor and/or the mixing device may comprise a control program to control the scale and thus the weighing.

As a device for the preparation of a food, an optical sensor may be provided in the food processor and/or in the mixing device by means of which an ingredient introduced into the vessel can be optically monitored. The food processor and/or the mixing device may comprise a control program to control the optical sensor and thus the optical monitoring.

Per the teaching of this paper, a mixing device according to the present disclosure is configured for solving the described task is provided. The mixing device can generally be used in the system.

The mixing device comprises of a standing part and a vessel which can be inserted into the standing part or is integrated into the standing part. Standing part means a part of the mixing device that is intended to be placed on a ground, for example on a countertop. The standing part may therefore have e.g. protruding knobs on the underside. The knobs contact the ground in the set-up state. The knobs can be made of an elastomer to enable non-slip set-up of the standing part and to dampen vibrations.

The standing part may have a recess that can accommodate a lower part of the vessel. The shape and diameter of the recess can correspond to the shape and diameter of the lower part of the vessel to hold the vessel securely and reliably in a desired position by the standing part.

A mixing tool is located in the vessel. The mixing tool can be located at the bottom of the vessel.

The standing part includes an electric drive to drive the mixing tool. The electric drive comprises a stepper motor. A stepper motor is particularly suitable for use in the mixing device, as the mixing tool should only be rotated at low speeds compared to the rotational speeds of a food processor. The mixing mechanism can therefore be connected directly to the shaft of the stepper motor. The installation space can therefore be small, so that the additional space required for the mixing device can be small.

In some embodiments, the electric drive of the mixing device is a hybrid stepper motor. A hybrid stepper motor can only be rotated at relatively low speeds. Since the mixing device is only used as a supplement to take over mixing tasks, only low speeds are even advantageous for safety reasons.

A hybrid stepper motor has also proven to be suitable because its torque is low in relation to its weight, which is also an advantage for safety reasons. Another advantage is that the torque does not or hardly depend on the speed.

A hybrid stepper motor is relatively heavy, especially compared to a piezoelectric stepper motor. Because the electric drive is located in the standing part, the hybrid stepper motor contributes to the relatively high weight of the standing part. A relatively high weight of the standing part is advantageous to ensure stability during operation. Nevertheless, the standing part can be small compared to a standard food processor. This can avoid space problems in a household.

The electric drive is principally located underneath the vessel when the vessel is inserted or integrated into the standing part and the standing part is set up as intended.

The electric drive can include a plurality of permanent magnets. Preferably, however, the electric drive comprises a rotor with only one permanent magnet. The installation effort can thus be kept particularly low.

In some embodiments, the electric drive comprises a stator with an annular shape and a rotor inside the annular shape. This design is particularly suitable for connecting a shaft of the electric drive with the mixing tool.

In some embodiments, segments having teeth protrude inwardly from the ring mold. A coil is wound around each segment. The rotor comprises outwardly protruding magnetically poled teeth.

In some embodiments, teeth of the stator can be exactly opposite teeth of the rotor. At the same time, other teeth of the stator can be arranged offset relative to other teeth of the rotor.

In some embodiments, the rotor comprises first teeth and second teeth. The first teeth are a magnetic north pole or are penetrated by a first magnetic flux of a magnet. The second teeth are a magnetic south pole or are penetrated by a second magnetic flux of a magnet in the opposite direction to the first magnetic flux. A first tooth can therefore be formed by the north pole of a permanent magnet. A second tooth can be formed by the south pole of a permanent magnet. However, the first and second teeth can be adjoined by a magnet such that the magnetic flux generated by the magnet penetrates the first and second teeth. The magnetic flux through the first teeth then runs in the reverse direction of the magnetic flux through the second teeth. The first teeth then act like a magnetic north pole, for example. The second teeth then act like a magnetic south pole. The first and second teeth are then magnetically poled in the sense of the present disclosure.

Principally, in the disclosed embodiment, first and second teeth form the outer circumference of the rotor. A first tooth is principally located between two second teeth and vice versa.

The rotor preferably comprises a first rotational body of ferromagnetic material which is provided with the first teeth. The rotor preferably comprises a second rotational body made of ferromagnetic material which is provided with the second teeth. The north pole of a permanent magnet preferably extends into the first rotational body. The south pole of the permanent magnet preferably extends into the second rotational body.

The teeth of the rotor are preferably outwardly curved on their upper side. The teeth of the stator are preferably inwardly curved on their upper side.

The mixing tool can comprise a blunt edge and an opposite sharp edge. The mixing device is configured such that the mixing tool can only be rotated in the direction of the blunt edge. By configuring the mixing device such that the mixing tool can only be rotated in the direction of the blunt edge, an undesired chopping of a food or of the ingredients of a food is avoided. Besides, this contributes to the safety of the mixing device. The mixing tool has an opposite sharp edge, so that the vessel with the mixing tool can also be used in a food processor. By means of the food processor which can rotate the mixing tool in the opposite direction, the ingredients of a food can then be chopped.

In some embodiments, the electric drive is connected to the mixing tool by a releasable coupling. The releasable coupling is located below the bottom of the vessel when the vessel is inserted into the recess of the standing part. With this embodiment the vessel can be detached from the standing part. With such an embodiment, the vessel can be operated with the standing part as well as with a corresponding food processor particularly easily.

In some embodiments, the coupling can be released by a linear movement along the motor shaft. The vessel can then be released from the standing part in an advantageous manner by lifting the vessel, i.e. moving it upwards away from the standing part.

1. A system comprising
a mixing device,
a food processor, and
at least one vessel with a mixing tool located therein, wherein the vessel with the mixing tool located therein can be used both as vessel of the food processor and as vessel of the mixing device, wherein the food processor comprises an electric drive for the mixing tool, wherein the mixing device comprises an electric drive for the mixing tool, wherein the food processor can rotate the mixing tool at a higher rotational speed than the mixing device, wherein the electric drive of the mixing device is a stepper motor.

2. The system of claim 1, wherein the food processor can rotate the mixing tool in two different directions.

3. The system of claim 1, wherein the food processor and the mixing device can be connected to each other via interfaces in such a way that they can exchange data with each other.

4. The system of claim 1, wherein the food processor comprises at least one of a scale for weighing ingredients in the vessel and a heating device for heating the device.

5. The system of claim 4, wherein the vessel comprises a heating device.

6. A mixing device comprising
a standing part and
a vessel configured to be inserted into the standing part or integrated into the standing part, and
a mixing tool in the vessel, wherein the standing part comprises an electric drive with which the mixing tool can be driven.

7. The mixing device of claim 6, wherein the electric drive of the mixing device comprises a rotor with only one permanent magnet.

8. The mixing device of claim 6, wherein the electric drive of the mixing device comprises a stator having an annular shape and a rotor inside the annular shape.

9. The mixing device of claim 8, wherein segments having teeth protrude inwardly from the annular shape, a coil is wound around each segment, and the rotor comprises outwardly protruding magnetically poled teeth.

10. The mixing device of claim 9, wherein teeth of the stator can be arranged exactly opposite teeth of the rotor and at the same time other teeth of the stator can be arranged offset relative to other teeth of the rotor.

11. The mixing device of claim 9, wherein the rotor comprises first teeth and second teeth and the first teeth are a magnetic north pole and the second teeth are a magnetic south pole or a first magnetic flux penetrates the first teeth and a second magnetic flux penetrates the second teeth in the opposite direction.

12. The mixing device of claim 11, wherein said rotor comprises a first rotational body of ferromagnetic material provided with said first teeth and a second rotational body of ferromagnetic material provided with said second teeth, wherein the north pole of a permanent magnet extends into said first rotational body and the south pole of said permanent magnet extends into said second rotational body.

13. The mixing device of claim 9, wherein the teeth of the rotor are outwardly curved on their upper side and the teeth of the stator are inwardly curved on their upper side.

14. The mixing device of claim 6, wherein the mixing tool has a blunt edge and an opposite sharp edge and the mixing device is configured such that the mixing tool can be rotated only in the direction of the blunt edge.

15. The mixing device of claim 6, wherein the electric drive of the mixing device is connected to the mixing tool by a releasable coupling provided below the bottom of the vessel.

16. The mixing device of claim 6, wherein the electric drive is a stepper motor.

17. The mixing device of claim 16, wherein the electric drive is a hybrid stepper motor.

18. A food preparation system, the system comprising
a vessel that defines a food preparation space,
a mixing device mounted to the vessel, the mixing device including a mixing tool arranged in the food preparation space and a vessel-mounted electric drive coupled to the mixing tool to drive rotation of the mixing tool so as to mix ingredients in the food preparations pace, and
a standing part upon which the vessel and mixing device are supported, the standing part including a stand-mounted electric drive coupled to the mixing tool while the vessel and mixing device are supported by the standing part to drive rotation of the mixing tool independent of the vessel-mounted electric drive so as to mix ingredients in the food preparation space,
wherein the vessel-mounted electronic drive is configured to drive the mixing tool up to a first speed, the stand-mounted electric drive is configured to drive the mixing tool up to a second speed greater than the first speed thereby allowing the ingredients to be mixed with the mixing tool spinning at speeds greater than is possible when the vessel and mixing device are not supported on the standing part while not requiring transfer the ingredients out of the vessel.

19. The food preparation system of claim 18, wherein the mixing tool has a blunt edge that engages the ingredients in the food preparation space when the mixing tool is rotated in a first direction to perform a mix function and an opposite sharp edge that engages the ingredients in the food preparation space when the mixing tool is rotated in a second direction to perform a chop function,
wherein the vessel-mounted electronic drive is configured to drive rotation of the mixing tool in only the first direction, and
wherein the stand-mounted electronic drive is capable of generating greater torque than the vessel-mounted electronic drive and is configured to selectively drive rotation of the mixing tool in both the first direction and the second direction so as to leverage the greater torque available when chopping the ingredients.

20. A food preparation system, the system comprising
a vessel that defines a food preparation space,
a mixing device mounted to the vessel, the mixing device including a mixing tool arranged in the food preparation space and a vessel-mounted electric drive coupled to the mixing tool to drive rotation of the mixing tool so as to mix ingredients in the food preparations pace, and
a standing part upon which the vessel and mixing device are supported, the standing part including a stand-mounted electric drive coupled to the mixing tool while the vessel and mixing device are supported by the standing part to drive rotation of the mixing tool independent of the vessel-mounted electric drive so as to mix ingredients in the food preparation space,
wherein the mixing tool has a blunt edge that engages the ingredients in the food preparation space when the mixing tool is rotated in a first direction to perform a mix function and an opposite sharp edge that engages the ingredients in the food preparation space when the mixing tool is rotated in a second direction to perform a chop function,
wherein the vessel-mounted electronic drive is configured to drive rotation of the mixing tool in only the first direction, and
wherein the stand-mounted electronic drive is capable of generating greater torque than the vessel-mounted electronic drive and is configured to selectively drive rotation of the mixing tool in both the first direction and the second direction so as to leverage the greater torque available when the mixing tool is performing the chop function.
